(19) United States
(12) Patent Application Publication
(10) Pub. No.: US 2013/0120527 A1
(43) Pub. Date: May 16, 2013

(54) ELECTRONIC APPARATUS AND DISPLAY CONTROL METHOD

(71) Applicant: Eita Shuto, Tokyo (JP)

(72) Inventor: Eita Shuto, Tokyo (JP)

(73) Assignee: KABUSHIKI KAISHA TOSHIBA, Tokyo (JP)

(21) Appl. No.: 13/612,688

(22) Filed: Sep. 12, 2012

(30) Foreign Application Priority Data
Nov. 11, 2011 (JP) 2011-247629

(51) Int. Cl. H04N 13/00

(52) U.S. Cl. 348/43; 348/E13.06

(57) ABSTRACT

According to one embodiment, an electronic apparatus includes a text image generator, a first image generator, a video composite module, and a display image generator. The text image generator generates a first text image which is different from a second text image if a display device is set in a 3D mode, the second text image being generated if the display device is set in a 2D mode. The first image generator generates a first image including the first text image for displaying 2D video. The video composite module generates a composite video frame by combining the first image and a video frame for displaying 3D video. The display image generator generates a display image by using the composite video frame.

### CROSS-REFERENCE TO RELATED APPLICATIONS

This application is based upon and claims the benefit of priority from Japanese Patent Application No. 2011-247629, filed Nov. 11, 2011, the entire contents of which are incorporated herein by reference.

### FIELD

Embodiments described herein relate generally to an electronic apparatus which plays back three-dimensional (3D) video, and a display control method which is applied to the electronic apparatus.

### BACKGROUND

In recent years, there are provided various electronic apparatuses for viewing three-dimensional (3D) video. An example of such electronic apparatuses is an electronic apparatus by a naked-eye stereoscopic method (naked-eye 3D method). In the naked-eye stereoscopic method, for example, a left-eye video image and a right-eye video image are simultaneously displayed on the screen of a liquid crystal display (LCD), and the directions of emission of light rays corresponding to the pixels in these video images are controlled by a lens which is disposed on the LCD.

On the screen, the pixels included in the left-eye video image and the pixels included in the right-eye video image are arranged in a predetermined order. For example, the pixels in the left-eye video image and the pixels in the right-eye video image are alternately arranged on the screen. The lens on the LCD controls the directions of emission of light rays corresponding to the arranged pixels. Thereby, a user can view the pixels of the left-eye video image by the left eye and the pixels of the right-eye video image by the right eye, thus being able to perceive 3D video (stereoscopic video).

There is known an electronic apparatus which displays 3D video, wherein the screen can be switched between a mode of displaying 3D video and a mode of displaying two-dimensional (2D) video. By switching the mode, the user can view 3D video and 2D video. For example, in the case of an electronic apparatus such as a personal computer, 2D video, such as a desktop screen, can be displayed in the 2D video display mode, and 3D video content can be displayed in the 3D video display mode.

However, in some cases, not only 3D video but also 2D video, such as a desktop screen, is displayed on the screen of the 3D video display mode. When the 2D video is displayed on the screen of the 3D video display mode, only a part of the 2D video can be viewed by each of the left eye and the right eye, and it is possible that the visibility of video lowers. In particular, it is possible that the visibility of a fine object included in 2D video, such as a character, considerably lowers.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating the external appearance of an electronic apparatus according to an embodiment.

FIG. 2 is an exemplary block diagram illustrating a configuration example of the electronic apparatus of the embodiment.

FIG. 3 is an exemplary view illustrating an example of a screen which is displayed by the electronic apparatus of the embodiment.

FIG. 4 is an exemplary view illustrating an example of the arrangement of sub-pixels for 3D video display by the electronic apparatus of the embodiment.

FIG. 5 is an exemplary block diagram illustrating an example of the structure of a desktop window manager which is executed by the electronic apparatus of the embodiment.

FIG. 6 is an exemplary flowchart illustrating an example of the procedure of a display control process which is executed by the electronic apparatus of the embodiment.

FIG. 7 is an exemplary flowchart illustrating another example of the procedure of the display control process which is executed by the electronic apparatus of the embodiment.

### DETAILED DESCRIPTION

Various embodiments will be described hereinafter with reference to the accompanying drawings.

In general, according to one embodiment, an electronic apparatus includes a text image generator, a first image generator, a video composite module, and a display image generator. The text image generator generates a first text image which is different from a second text image if a display device is set in a three-dimensional video display mode, the second text image being generated if the display device is set in a two-dimensional video display mode. The first image generator generates a first image for displaying two-dimensional video, the first image including the first text image. The video composite module generates a composite video frame by combining the first image and a video frame including a plurality of images for displaying three-dimensional video. The display image generator generates a display image by using the composite video frame, the display image being to be displayed on a screen of the display device.

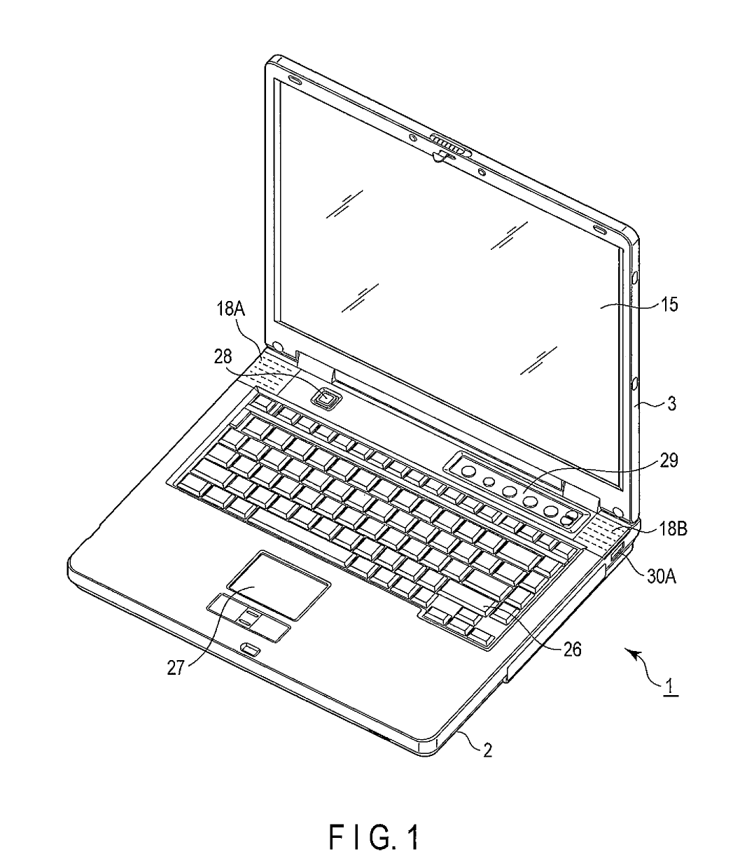

FIG. 1 is a perspective view showing the external appearance of an electronic apparatus according to an embodiment. The electronic apparatus is realized, for example, as a notebook-type personal computer 1. In addition, this electronic apparatus may be realized as a television (TV) receiver, a personal video recorder for recording and playing video data (e.g. a hard disk recorder or a DVD recorder), a tablet PC, a slate PC, a PDA, a car navigation apparatus, a smartphone, or a video game machine.

As shown in FIG. 1, the computer 1 includes a computer main body 2 and a display unit 3.

A three-dimensional display device (3D display device) 15 is built in the display unit 3. The display unit 3 is attached to the computer main body 2 such that the display unit 3 is rotatable between an open position where the top surface of the computer main body 2 is exposed, and a closed position where the top surface of the computer main body 2 is covered. In addition, the 3D display device 15 is a naked-eye 3D display which includes a liquid crystal display (LCD) and a lens unit. The lens unit is attached on the LCD. The lens unit includes a plurality of lens mechanisms for emitting, in predetermined directions, a plurality of light rays corresponding to a plurality of pixels included in a video image that is displayed on the LCD.

The lens unit is, for example, a liquid crystal gradient index (GRIN) lens which electrically switches functions necessary for 3D video display. In the liquid crystal GRIN lens, a refractive index distribution is created by electrodes with use of a planar liquid crystal layer. Thus, by varying the refractive index of the lens, the entire screen of the 3D display device 15 can be used in either a three-dimensional (3D) video display mode for displaying three-dimensional (3D) video or a two-dimensional (2D) video display mode for displaying two-dimensional (2D) video.

The 3D display device 15 displays a plurality of parallax images corresponding to a plurality of view points (e.g. left-eye video and right-eye video corresponding to two view points) when the 3D display device 15 is set in the 3D video display mode, and displays 2D video when the 3D display device 15 is set in the 2D video display mode. Thereby, the user can perceive 3D video when viewing the screen set in the 3D video display mode, and can perceive 2D video when viewing the screen set in the 2D video display mode.

The computer main body 2 has a thin box-shaped housing. A keyboard 26, a power button 28 for powering on/off the computer 1, an input operation panel 29, a pointing device 27 such as a touch pad, and speakers 18A and 18B are disposed on the top surface of the housing of the computer main body 2. Various operation buttons are provided on the input operation panel 29. The buttons include operation buttons for controlling a TV function (viewing, recording, and playback of recorded broadcast program data/video data).

An antenna terminal 30A for TV broadcast is provided, for example, on a right-side surface of the computer main body 2. In addition, an external display connection terminal supporting, e.g. the high-definition multimedia interface (HDMI) standard is provided, for example, on a rear surface of the computer main body 2. This external display connection terminal is used for outputting video data (moving picture data) included in video content data, such as broadcast program data, to an external display.

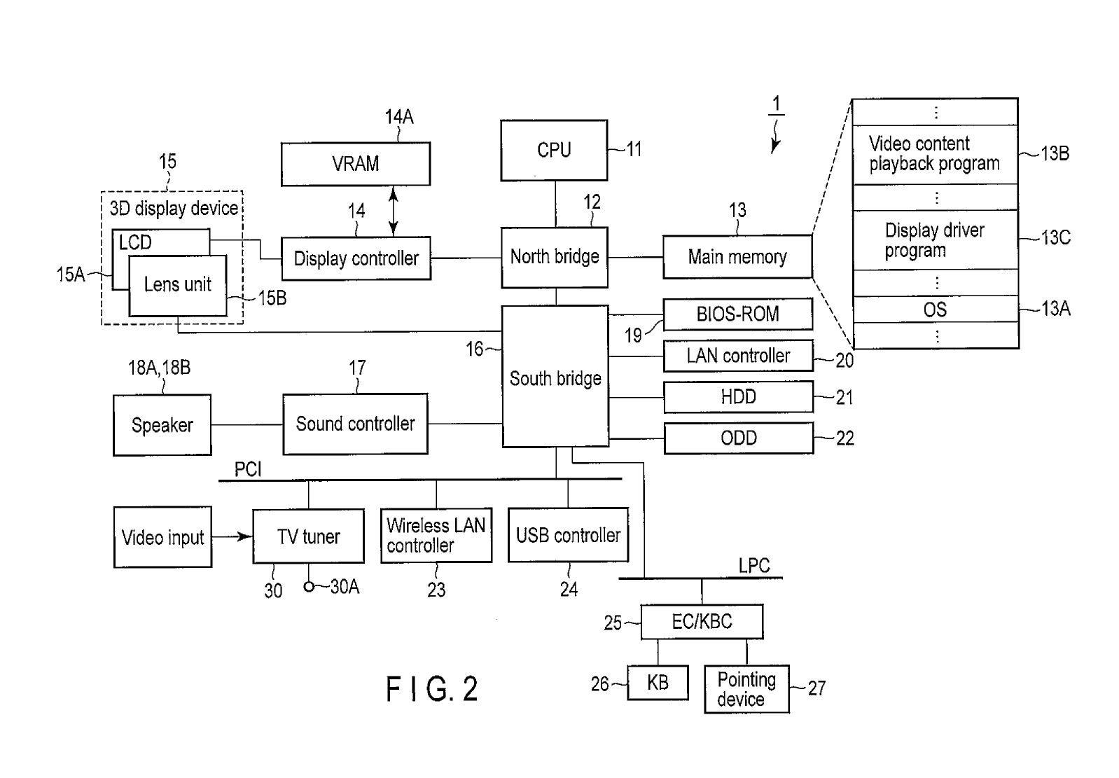

FIG. 2 shows the system configuration of the computer 1.

The computer 1, as shown in FIG. 2, includes a CPU 11, a north bridge 12, a main memory 13, a display controller 14, a video memory (VRAM) 14A, 3D display device 15, a south bridge 16, a sound controller 17, speakers 18A and 18B, a BIOS-ROM 19, a LAN controller 20, a hard disk drive (HDD) 21, an optical disc drive (ODD) 22, a wireless LAN controller 23, a USB controller 24, an embedded controller/keyboard controller (EC/KBC) 25, keyboard (KB) 26, pointing device 27, and a TV tuner 30.

The CPU 11 is a processor for controlling the operation of the computer 1. The CPU 11 executes an operating system (OS) 13A, a driver program such as a display driver program 13C and an application program such as a video content playback program 13B, which are loaded from the HDD 21 into the main memory 13.

The OS 13A includes a function (also referred to as “desktop window manager”) for generating 2D video such as a desktop screen. The OS 13A generates images of a background, an icon, a taskbar, a toolbar, a dialog, a window corresponding to an application program which is being executed, a pop-up, etc. which are displayed on the screen as the 2D video. In addition, the OS 13A updates the 2D video which is displayed on the screen, in accordance with user's operations and various processes.

The video content playback program 13B is software having a function for viewing video content data. The video content playback program 13B executes a live playback process for viewing broadcast program data which is received by the TV tuner 30, a recording process for recording the received broadcast program data in the HDD 21, a playback process for playing back broadcast program data/video data which is recorded in the HDD 21, and a playback process for playing back video content data which is received via a network. In addition, the video content playback program 13B may play back video content data which is stored in storage media such as a DVD or a BD®, or in a storage device such as a hard disk.

Further, the video content playback program 13B includes a function for viewing 3D video. The video content playback program 13B displays on the screen of the 3D display device 15 the 3D video based on video content data (or broadcast program data) that is a target of playback. Specifically, the video content playback program 13B generates video frames for displaying 3D video, by using the target video content data. As the format of the video frame, use is made of, for example, a side-by-side format or a top-and-bottom format. The video frame of the side-by-side image is a video frame in which a left-eye image and a right-eye image are arranged in the left-and-right direction. The video frame of the top-and-bottom format is a video frame in which a left-eye image and a right-eye image are arranged in the up-and-down direction. Besides, the format of the video frame may be, for example, a format in which parallax images corresponding to a greater number of view points are arranged, such as a format in which parallax images of four view points are arranged in 2×2 areas, or a format in which parallax images of nine view points are arranged in 3×3 areas.

In addition, the video content playback program 13B may convert 2D video, which is included in video content data, to 3D video in real time, and display the 3D video on the screen. The video content playback program 13B can 2D to 3D convert various content data (e.g. broadcast program data, video data stored in storage media or storage device, or video data received from a server on the Internet). Specifically, the video content playback program 13B generates video frames for displaying 3D video by 2D to 3D conversion.

For the display of 3D video, use may be made of the 3D display device 15 by, e.g. a naked-eye stereoscopic method (e.g. an integral imaging method, a lenticular method, or a parallax barrier method). The user can perceive 3D video by the naked eyes by viewing video which is displayed on the 3D display device 15 of the naked-eye stereoscopic method.

Besides, the CPU 11 executes a basic input/output system (BIOS) that is stored in the BIOS-ROM 19. The BIOS is a program for hardware control.

The north bridge 12 is a bridge device which connects a local bus of the CPU 11 and the south bridge 16. The north bridge 12 includes a memory controller which access-controls the main memory 13. The north bridge 12 also has a function of communicating with the display controller 14.

The display controller 14 is a device which controls the LCD 15A that is used as a display of the computer 1. A display signal, which is generated by the display controller 14, is sent to the LCD 15A. The LCD 15A displays video, based on the display signal.

The south bridge 16 controls devices on a Peripheral Component Interconnect (PCI) bus and devices on a Low Pin Count (LPC) bus. The south bridge 16 includes an Integrated Drive Electronics (IDE) controller for controlling the HDD 21 and ODD 22, and a memory controller which access-controls the BIOS-ROM 19. The south bridge 16 also has a function of communicating with the sound controller 17 and LAN controller 20.

Furthermore, the south bridge 16 output a control signal to the lens unit 15B in accordance with, e.g. a request by the video content playback program 13B. The control signal is used for executing such control as to set the lens unit 15B in either the 3D video display mode or the 2D video display mode. The lens unit 15B is set in either the 3D video display mode or the 2D video display mode by varying, for example, the refractive index of the liquid crystal layer in accordance with the control signal output by the south bridge 16.

The sound controller 17 is a sound source device and outputs audio data, which is a target of playback, to the speakers 18A and 18B. The LAN controller 20 is a wired communication device which executes wired communication of, e.g. the Ethernet® standard. The wireless LAN controller 23 is a wireless communication device which executes wireless communication of, e.g. the IEEE 802.11 standard. In addition, the USB controller 24 communicates with an external device via a cable of, e.g. the USB 2.0 standard.

The EC/KBC 25 is a one-chip microcomputer in which an embedded controller for power management and a keyboard controller for controlling the keyboard (KB) 26 and pointing device 27 are integrated. The EC/KBC 25 has a function of powering on/off the computer 1 in accordance with the user's operation.

The TV tuner 30 is a reception device which receives broadcast program data that is broadcast by a television (TV) broadcast signal. The TV tuner 30 is connected to the antenna terminal 30A. The TV tuner 30 is realized as a digital TV tuner which can receive digital broadcast program data of, e.g. ground digital TV broadcast. In addition, the TV tuner 30 has a function of capturing video data which is input from an external device.

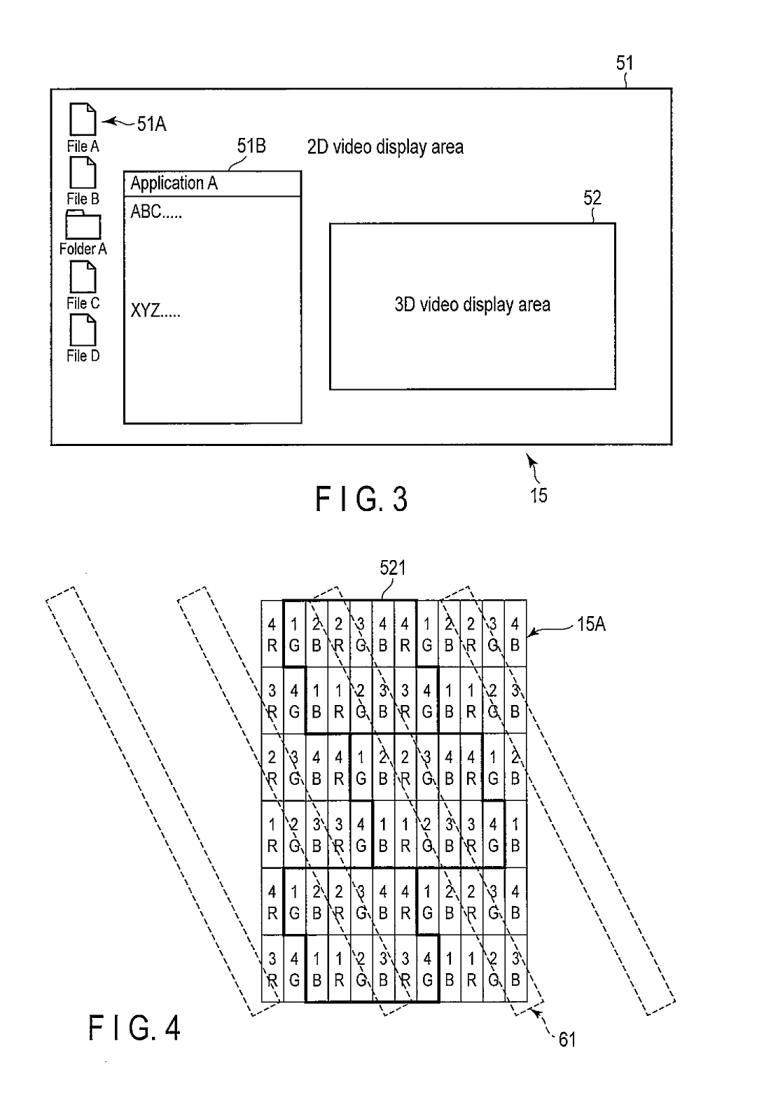

FIG. 3 is a view illustrating an example of the screen of the 3D display device 15 which is set in the 3D video display mode. As shown in FIG. 3, there is a case in which not only 3D video but also 2D video is displayed on the 3D display device 15 which is set in the 3D video display mode. In an area (hereinafter referred to as “3D video display area”) 52 in which 3D video is displayed, the pixels included in a plurality of parallax images corresponding to a plurality of view points (e.g. a left-eye video image and a right-eye video image corresponding to two view points) are arranged in a predetermined pattern for 3D video display. The directions of emission of light rays corresponding to the pixels arranged in the 3D video display area 52 are controlled by the lens unit 15B. For example, when the pixels of the left-eye video image and the pixels of the right-eye video image are arranged in a predetermined pattern in the 3D video display area 52, the lens unit 15B controls the directions of light rays so that the light rays corresponding to the pixels of the left-eye video image may be perceived by the left eye and the light rays corresponding to the pixels of the right-eye video image may be perceived by the right eye. Thereby, the user can perceive 3D video by viewing the 3D video display area 52.

On the other hand, in an area (hereinafter “2D video display area”) 51 in which 2D video is displayed, the pixels corresponding to 2D video, such as a desktop screen, are arranged. The 2D video includes objects such as an icon, a taskbar, a toolbar, a dialog, a window corresponding to an application program which is being executed, a pop-up, etc. In some cases, the objects include text (character). For example, in an icon 51A, text indicative of the name of an associated file or folder (directory) is displayed. In addition, for example, in a window 51B, the name of an associated application program or the name of a file that is the target of processing is displayed in the title bar of the window 51B. In the window 51B, text indicative of the content of the file that is the target of processing (e.g. text included in a document file) is displayed. Furthermore, in the case of a button arranged in a dialog or the like, text (e.g. “OK”, “Cancel”) indicative of the function of the button is displayed on the button.

Since the 3D display device 15 is set in the 3D video display mode, the pixels arranged in the 2D video display area 51 are treated like the pixels arranged in the 3D video display area 52. Specifically, the 3D display device 15 treats the pixels arranged in the 2D video display area 51 as being pixels arranged in a predetermined pattern for 3D video display. Thus, in the 2D video display mode, all the pixels on the screen (i.e. all pixels in the 2D video) can be viewed, but in the 3D video display mode, only a part of pixels on the screen can be viewed by each of the left eye and right eye of the user.

Like the case of the 3D video display area 52, the directions of emission of light rays corresponding to the pixels arranged in the 2D video display area 51 are controlled by the lens unit 15B. The lens unit 15B controls the directions of light rays so that, for example, the light ray corresponding to a certain pixel in the 2D video (i.e. a pixel at a position where a pixel for a left-eye image is to be disposed) may be perceived by the left eye and the light ray corresponding to another pixel in the 2D video (i.e. a pixel at a position where a pixel for a right-eye image is to be disposed) may be perceived by the right eye. Consequently, since only a part of the 2D video can be viewed by each of the left eye and right eye, it is possible that the visibility of the 2D video by the user lowers. In particular, it is possible that the visibility of a fine object included in 2D video, such as a character (text), considerably lowers, since a part of the character may appear to be missing or the color of the character may be disturbed (e.g. the character appears in a color different from the actual color).

Besides, in the 3D video display area 52, not only two parallax images corresponding to two view points, but also a plurality parallax images corresponding to a greater number of view points, such as four parallax images corresponding to four view points, may be used, and the pixels included in the respective parallax images may be arranged in a predetermined pattern for 3D video display. With the pixels of four parallax images being arranged on the screen (LCD) 15A, the user can view 3D video, not only in the frontal direction of the 3D display device 15, but also from a position which deviates slightly from the frontal direction. For example, this configuration is used in a large-screen television, which is assumed to be viewed by a plurality of persons.

FIG. 4 is a view illustrating an example in which the pixels included in four parallax images corresponding to four view points are arranged on the screen 15A. On the screen 15A, the pixels included in the four parallax images are arranged in a predetermined pattern. Three sub-pixels, namely R (red), G (green) and B (blue) sub-pixels, are arranged in association with one pixel.

Specifically, in an area 521 in the screen 15A, for example, three sub-pixels 1R, 1G and 1B corresponding to a pixel of a first parallax image, three sub-pixels 2R, 2G and 2B corresponding to a pixel of a second parallax image, three sub-pixels 3R, 3G and 3B corresponding to a pixel of a third parallax image, and three sub-pixels 4R, 4G and 4B corresponding to a pixel of a fourth parallax image, are arranged in a predetermined pattern. In the example illustrated in FIG. 4, the sub-pixels corresponding to the pixels of the four parallax images are not regularly arranged in the horizontal direction and vertical direction, but these sub-pixels are arranged in a complicated fashion. When the sub-pixels (pixels) corresponding to the four parallax images are arranged with this pattern, the directions of emission of light rays corresponding to the sub-pixels are controlled by the lens unit 15B.

Since the user views the 3D display device 15 from an arbitrary position, for example, the pixels in a slit-shaped area 61 (in this example, the pixels of the second parallax image and the pixels of the third parallax image) are viewed by one of the eyes of the user. In addition, the pixels in another slit-shaped area (e.g. the pixels of the third parallax image and the pixels of the fourth parallax image) are viewed by the other of the eyes of the user. The user can perceive 3D video by viewing the slit-shaped area 61 by one of the eyes and viewing the other slit-shaped area by the other eye.

In the 3D display device 15 that is set in the 3D video display mode, the pixels (sub-pixels) are arranged in the predetermined pattern shown in FIG. 4, and the directions of emission of light rays corresponding to the pixels are controlled in accordance with this pattern. In addition as described above, the 3D display device 15 treats the pixels of 2D video, which are arranged in the 2D video display area 51, as being pixels arranged in the predetermined pattern for 3D video display.

Consequently, when 2D video is displayed on the 3D display device 15 that is set in the 3D video display mode, only a part of the 2D video (i.e. the slit-shaped area in the 2D video) can be viewed by each of the left eye and right eye of the user. Thus, it is possible that the visibility of 2D video by the user lowers. In particular, since a character (text) in the 2D video is a fine object, a part of the character may appear to be missing. In addition, in the slit-shaped area in the 2D video, it is possible that a sub-pixel of a certain pixel and a sub-pixel of another pixel (e.g. sub-pixel 1R of a first pixel and sub-pixels 2G and 2B of a second pixel neighboring the first pixel) are mixed. Hence, in some cases, a pixel of a color (i.e. a color perceived by sub-pixels 1R, 2G and 2B), which is different from the actual color of the pixel in the 2D video, may appear. Thus, in the 3D display device 15 that is set in the 3D video display mode, it is possible that the visibility of a character included in the 2D video considerably lowers.

Taking the above into account, in the computer 1, when 2D video is displayed on the 3D display device 15 that is set in the 3D video display mode, a character (text) included in the 2D video is subjected to a predetermined process, thereby enhancing the visibility of the character.

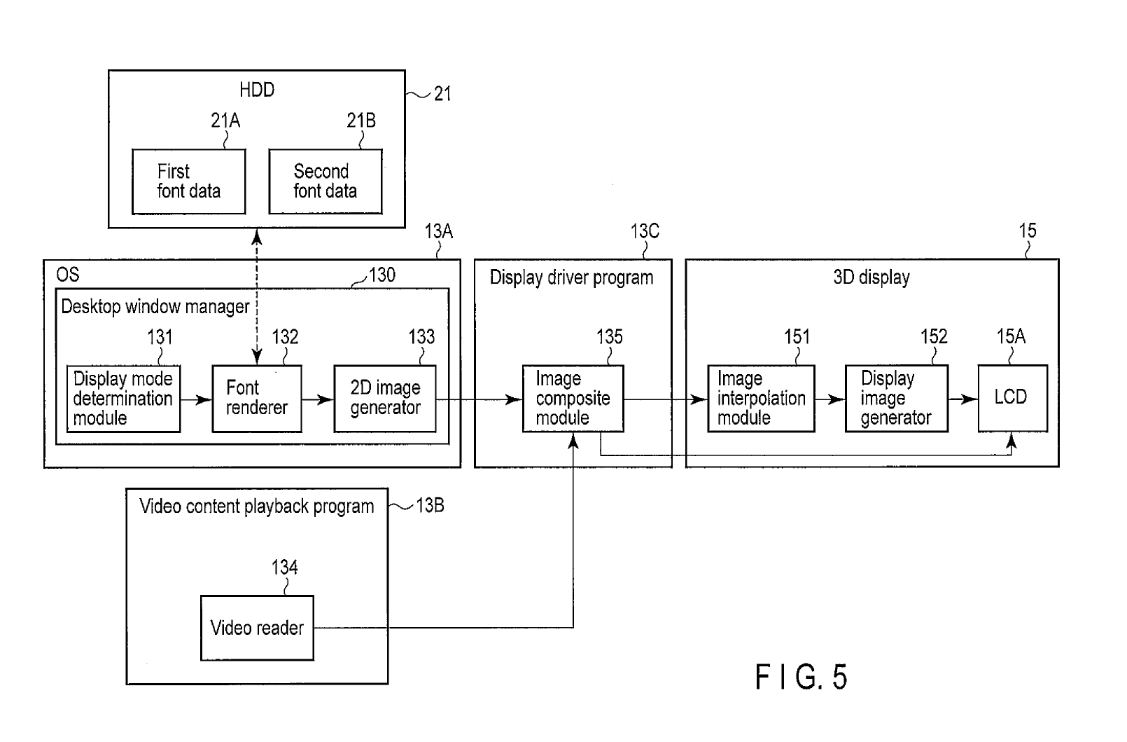

FIG. 5 illustrates a configuration example for improving the visibility of a character in 2D video which is displayed on the 3D display device 15. A video image for displaying 3D video, which is generated by the video content playback program 13B, and a video image for displaying 2D video, which is generated by the OS 13A, are combined by the display driver program 13C, and the composite video is displayed on the 3D display device 15. In the description below, for the purpose of simple description, it is assumed that 2D video, such as a desktop screen, is displayed on the screen when the 3D display device 15 is set in the 2D video display mode, and 2D video, such as a desktop screen, and 3D video, which is played back by the video content playback program 13B, are displayed on the screen when the 3D display device 15 is set in the 3D video display mode.

The OS 13A includes a desktop window manager 130. The desktop window manager 130 generates, for example, 2D video (a video signal of 2D video) which is displayed as a desktop screen. The desktop window manager 130 generates 2D video including, for example, a background, an icon, a taskbar, a toolbar, a dialog, a window corresponding to an application program which is being executed, a pop-up, etc. In addition, the desktop window manager 130 generates 2D video such as a cursor which indicates a position designated by the pointing device 27 such as a mouse or a touch pad. The window manager 130 includes a display mode determination module 131, a font renderer 132 and a 2D image generator 133.

The display mode determination module 131 determines whether the 3D display device 15 is set in the 3D video display mode or in the 2D video display mode. The display mode determination module 131 outputs to the font renderer 132 a determination result indicating whether the 3D display device 15 is set in the 3D video display mode or in the 2D video display mode.

Based on the determination result by the display mode determination module 131, the font renderer 132 generates an image of text (character), which is included in 2D video that is to be displayed on the screen. The text includes a character which is used in, e.g. a window, an icon, a taskbar, a toolbar, a dialog, or a pop-up, which is displayed on the screen.

Specifically, in the case of the determination result indicating that the 3D display device 15 is set in the 2D video display mode, the font renderer 132 reads second font data 21B from the HDD 21, and then generates an image of text (also referred to as “second text image”) by using the second font data 21B. The second text image is, for example, an image of a bitmap format. In addition, the second font data 21B includes data of a second font (system font) which is used in the 2D video display mode.

On the other hand, in the case of the determination result indicating that the 3D display device 15 is set in the 3D video display mode, the font renderer 132 generates a first text image which is different from the second text image that is generated when the 3D display device 15 is set in the 2D video display mode. For example, the font renderer 132 generates an image of text (first text image) in which neighboring pixels are set in the same color or in similar colors. Specifically, the font renderer 132 reads first font data 21A from the HOD 21, and generates the first text image by using the first font data 21A. The first font data 21A includes, for example, data of a first font which is greater in line width than the second font that is used in the 2D video display mode. In the meantime, the first font data 21A may include data of the first font in boldface type. In the 3D video display mode, an image of text using the first font with a thick line width is generated. Thereby, as in the area 521 in FIG. 4, predetermined neighboring pixel areas on the screen can easily be set in the same color or in similar colors. In the area 521, four pixels (12 sub-pixels), which are associated with the pixels in the parallax images corresponding to four view points, are disposed. The font renderer 132 generates the first text image, for example, in such a manner that these four pixels are set in the same color or in similar colors. Thereby, when 2D video is displayed on the 3D display device 15 that is set in the 3D video display mode, the text (character) can be made easier to view, even if a part of the 2D video appears to be missing.

In addition, the font renderer 132 may switch the function of the font renderer, based on the determination result by the display mode determination module 131. For example, in the case of the determination result indicating that the 3D display device 15 is set in the 2D video display mode, a second font renderer having an antialiasing function generates a text image (second text image). The second font renderer generates an image of text by using, for example, predetermined font data, and subjects the generated text to an antialiasing process. In this antialiasing process, for example, a contour portion of character image is changed to (replaced with) a pixel of an intermediate color between the character color and the background color, so that the contour of the character image may become smooth (i.e. so that jaggy occurring at the contour of the character image may be suppressed). For example, when a black character is drawn on a white background, a contour portion of the character image is changed to a gray or green pixel.

On the other hand, in the case of the determination result indicating that the 3D display device 15 is set in the 3D video display mode, a first font renderer having no antialiasing function generates an image of text (first text image). The first font renderer generates an image of text, which is not subjected to an antialiasing process, for example, by using predetermined font data. Specifically, the first font renderer does not execute the antialiasing process, so that a pixel of an intermediate color between the character color and the background color may not be used for the contour portion of the character image. In the 3D video display mode, the image of the text, which is not subjected to the antialiasing process, is generated, and thereby, as in the area 521 shown in FIG. 4, predetermined neighboring pixel areas on the screen can easily be set in the same color or in similar colors. In the area 521, four pixels (12 sub-pixels), which are associated with the pixels in the parallax images corresponding to four view points, are disposed. The font renderer 132 generates the image of text, for example, in such a manner that these four pixels are set in the same color or in similar colors. Thereby, when 2D video is displayed on the 3D display device 15 that is set in the 3D video display mode, the text (character) can be made easier to view, even if a part of the 2D video appears to be missing.

In the case of the determination result indicating that the 3D display device 15 is set in the 3D video display mode, the font renderer 132 may generate an image of text (first text image), which is not subjected to the antialiasing process, by using the first font data 21A. The font renderer 132 outputs the generated image of text to the 3D image generator 133.

The 2D image generator 133 generates a first image including the image of text (first text image or second text image) generated by the font renderer 132. For example, the 2D image generator 133 generates a first image for displaying 2D video, by superimposing a text image on an associated image corresponding to a window, an icon, a button, a taskbar, a toolbar, a dialog, or a pop-up, which is displayed on the screen. The 2D image generator 133 outputs the generated first image to the display driver program 13C.

In addition, the video content playback program 13B includes a video reader 134.

The video reader 134 reads video content data that is a target of playback, for example, from the HDD 21. The video reader 134 may read video content data from a DVD or BD which is loaded in the ODD 22. Further, the video reader 134 may receive video content data via a network. The video content data includes, for example, 3D video data corresponding to a plurality of video frames for displaying 3D video. Each of the plural video frames is a video frame in which a plurality of parallax images with a first resolution are arranged based on a first format. To be more specific, each of the plural video frames is, for example, an image in which parallax images of two view points (e.g. a left-eye video image and a right-eye video image) are arranged in two areas provided in a video frame, like a side-by-side format or a top-and-bottom format (half format). In the meantime, each of the plural video frames may be, for example, an image in which parallax images corresponding to a greater number of view points are arranged, such as an image in which parallax images of four view points are arranged in 2×2 areas, or an image in which parallax images of nine view points are arranged in 3×3 areas.

The video reader 134 successively sets the plural video frames, from the first one, to be the video frame that is the target of processing. The video frame is, for example, a video frame including a plurality of parallax images for displaying 3D video. The video reader 134 outputs the set target video frame to the display driver program 13C. In the meantime, the video reader 134 may output a video frame, which has been generated by 2D to 3D conversion, to the display driver program 13C.

The display driver program 13C includes an image composite module 135. The image composite module 135 generates video (composite video frame) in which a first image, which has been output by the 2D image generator 133, and a video frame, which has been output by the video reader 134, are combined. The image composite module 135 generates a composite video frame, for example, by superimposing a video frame for displaying 3D video at a predetermined position on the first image for displaying 2D video (i.e. at a position corresponding to the 3D video display area 52). The image composite module 135 outputs the generated composite video frame to the 3D display device 15.

The 3D display device 15 includes an image interpolation module 151 and a display image generator 152.

The 3D display device 15 generates a plurality of interpolated parallax images by using an image corresponding to the 3D video frame in the composite image frame which has been output by the image composite module 135. A plurality of parallax images with a first resolution are included in the image corresponding to the 3D video frame. Using the plural parallax images with the first resolution, the image interpolation module 151 generates a plurality of parallax images with a second resolution which is higher than the first resolution. The image interpolation module 151 outputs to the display image generator 152 the generated plural parallax images and the image corresponding to the first image in the composite video frame.

The display image generator 152 generates a display image which is to be displayed on the LCD 15A, by using the image corresponding to the first image, and the plural parallax images, which have been output by the image interpolation module 151. Using the images which have been output by the image interpolation module 151, the display image generator 152 generates a display image in which pixels are rearranged in units of a sub-pixel in accordance with the arrangement of pixels (sub-pixels) on the LCD 15A. Specifically, the display image generator 152 arranges the pixels, which are included in the image corresponding to the first image, in the associated area (pixels) 51 in the display image. Then, the display image generator 152 arranges the pixels, which are included in the plural parallax images, with a predetermined pattern (a pattern for 3D video display) in the associated area 52 in the display image. For example, the display image generator 152 arranges the pixels of the first parallax image in the area (pixels) which is controlled to be perceived at the first view point by the lens unit 15B. Similarly, the display image generator 152 arranges the pixels of the second parallax image in the area (pixels) which is controlled to be perceived at the second view point by the lens unit 15B. The display image generator 152 arranges the pixels of the third parallax image in the area (pixels) which is controlled to be perceived at the third view point by the lens unit 15B. The display image generator 152 arranges the pixels of the fourth parallax image in the area (pixels) which is controlled to be perceived at the fourth view point by the lens unit 15B. Then, the display image generator 152 outputs the generated display image to the LCD 15A.

The LCD 15A displays the display image, which has been output by the display image generator 152, on the screen. A plurality of light rays corresponding to a plurality of pixels included in the displayed image are controlled to be emitted in predetermined directions by the lens unit 15B. Thereby, the user can perceive 3D video which is displayed on the 3D video display area 52. In addition, as regards the 2D video displayed in the 2D video display area 51, since the directions of emission of light rays are controlled by the lens unit 15B, it is possible that only a part of the 2D video can be viewed by each of the left eye and right eye, and that a part of the 2D video appears to be missing. However, since the character included in the displayed 2D video is rendered, for example, as a character with a thick line width, the effect due to partial missing of the 2D video can be suppressed. Therefore, when 2D video is displayed on the 3D display device 15 that is set in the 3D video display mode, the visibility of the character included in the 2D video can be improved. Incidentally, the above-described image interpolation module 151 and display image generator 152 may be provided not in the 3D display device 15, but in the display controller 14.

When 3D video content data is not played back by the video content playback program 13B, the video reader 134 does not output the video frame to the image composite module 135, and the display mode of the 3D display device 15 is set in the 2D video display mode. In this case, the image composite module 135 outputs the first image, which has been output by the 2D image generator 133, to the 3D display device 15 (LCD 15A). Then, the LCD 15A outputs the first image to the screen. Specifically, the first image, such as a desktop image, is displayed as such on the 3D display device 15 that is set in the 2D video display mode.

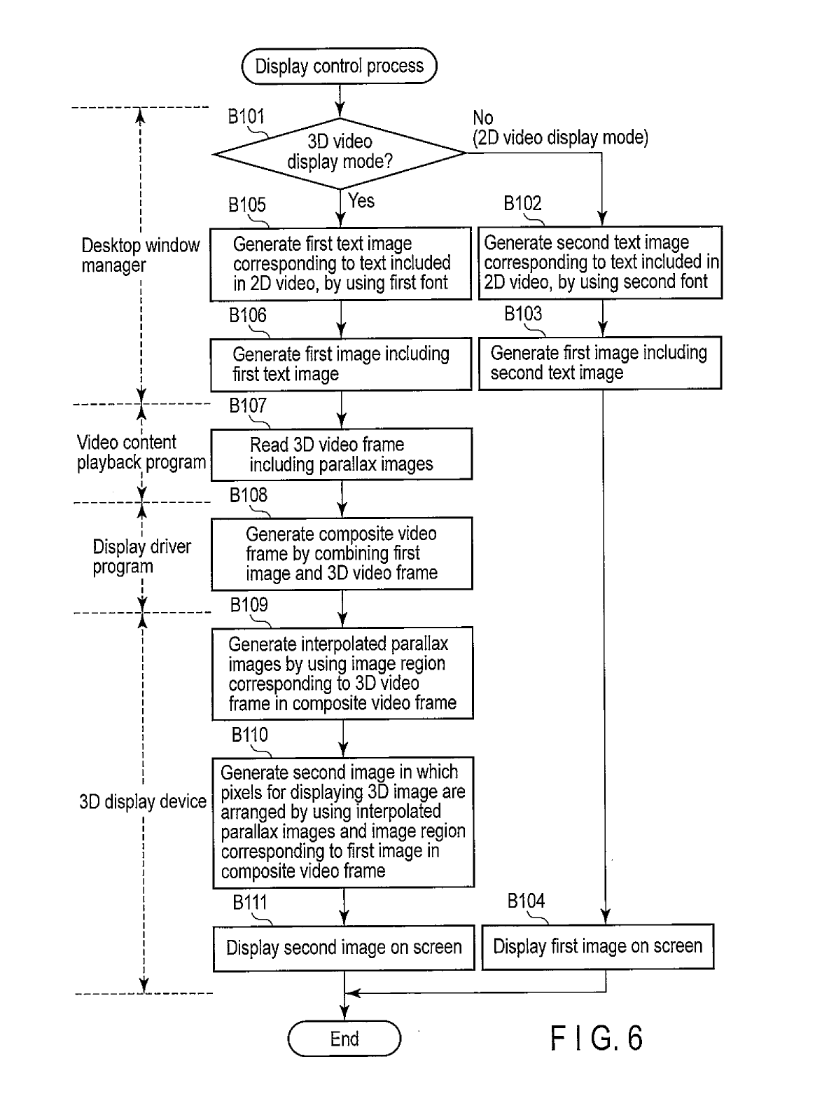

Next, referring to a flowchart of FIG. 6, a description is given of an example of the procedure of a display control process which is executed by the computer 1. In the description below, for the purpose of simple description, it is assumed that 2D video, such as a desktop screen, is displayed on the screen when the 3D display device 15 is set in the 2D video display mode, and 2D video, such as a desktop screen, and 3D video, which is played back by the video content playback program 13B, are displayed on the screen when the 3D display device 15 is set in the 3D video display mode.

To begin with, the display mode determination module 131 of the desktop window manager 130 determines whether the display mode of the 3D display device 15 is the 3D video display mode or not (block B101). The display mode of the 3D display device 15 is set to be the 3D video display mode, for example, when the video content playback program 138 plays back (reproduces) 3D video content data for displaying 3D video. The display mode of the 3D display device 15 is restored to the 2D video display mode, for example, when the playback of the 3D video content data by the video content playback program 13B has been finished. In addition, the display mode of the 3D display device 15 is set to be the 2D video display mode, for example, when the video content playback program 13B plays back (reproduces) 2D video content data for displaying 2D video. Besides, the display mode of the 3D display device 15 may be switched in accordance with an instruction (operation) by the user.

If the display mode of the 3D display device 15 is the 2D video display mode (NO in block B101), the font renderer 132 generates an image of text (character) (second text image), which is included in 2D video that is to be displayed on the screen, by using the second font data 21B stored in, e.g. the HDD 21 (block B102). The text includes a character which is used in, e.g. a window, an icon, a taskbar, a toolbar, a dialog, or a pop-up, which is displayed on the screen. In addition, the second font data 21B includes data of a second font (system font) which is used in the 2D video display mode. The 2D image generator 133 generates a first image including the second text image in which the second font is used (block B103). For example, the 2D image generator 133 generates a first image by superimposing a second text image corresponding to text on an associated image corresponding to a window, an icon, a button, a taskbar, a toolbar, a dialog, or a pop-up, which is displayed on the screen. Then, the LCD 15A displays the generated first image on the screen (block B104).

On the other hand, if the display mode of the 3D display device 15 is the 3D video display mode (YES in block B101), the font renderer 132 generates an image of text (character) (first text image), which is included in 2D video that is to be displayed on the screen, by using the first font data 21A stored in, e.g. the HDD 21 (block B105). As described above, the text includes a character which is used in, e.g. a window, an icon, a taskbar, a toolbar, a dialog, or a pop-up, which is displayed on the screen. In addition, the first font data 21A includes, for example, data of a first font which is greater in line width than the second font that is used in the 2D video display mode. In the meantime, the first font data 21A may include data of the first font in boldface type. The 2D image generator 133 generates a first image including the first text image in which the first font is used (block B106). Specifically, if the display mode of the 3D display device 15 is the 3D video display mode, the 2D image generator 133 generates a first image including the first text image in which the first font with a thick line width is used. The 2D image generator 133 outputs the generated first image to the image composite module 135 of the display driver program 13C.

Subsequently, the video reader 134 of the video content playback program 13B successively reads a plurality of 3D video frames included in 3D video data that is the target of playback (block B107). The 3D video frame includes a plurality of parallax images corresponding to a plurality of view points (e.g. left-eye video and right-eye video corresponding to two view points) for displaying 3D video. The video reader 134 outputs the read 3D video frame to the image composite module 135.

The image composite module 135 combines the first image, which has been output by the 2D image generator 133, and the 3D video frame which has been output by the video reader 134 (block B108). The image composite module 135 generates a combined video frame (composite video frame), for example, by superimposing the 3D video frame at a predetermined position on the first image (i.e. at a position corresponding to the 3D video display area 52).

Next, the image interpolation module 151 of the 3D display device 15 generates interpolated parallax images by using the image corresponding to the 3D video frame in the composite video frame (block B109). Specifically, the image interpolation module 151 detects, for example, a left-eye image and a right-eye image, which have a first resolution, from the image corresponding to the 3D video frame. The image interpolation module 151 interpolates the left-eye image of the first resolution, thereby generating a left-eye image of a second resolution (for displaying 3D video on the 3D display device 15) which is higher than the first resolution. The image interpolation module 151 also interpolates the right-eye image of the first resolution, thereby generating a right-eye image of the second resolution (for displaying 3D video on the 3D display device 15).

Then, the display image generator 152 generates a display image in which pixels are arranged in accordance with the arrangement of pixels (sub-pixels) on the LCD 15A, by using the generated parallax images (e.g. left-eye image and right-eye image of the second resolution), and the image corresponding to the first image in the composite video frame (block B110). Specifically, the display image generator 152 arranges the pixels in the image corresponding to the first image, in the associated area in the display image. Then, the display image generator 152 arranges the pixels in the generated parallax images (the pixels in the left-eye image and the pixels in the right-eye image), with a predetermined pattern (a pattern for 3D video display). Then, the LCD 15A displays the generated display image on the screen (block B111).

By the above-described process, when 2D video is displayed on the 3D display device 15 that is set in the 3D video display mode, since the font with a large line thickness is used for the image of the character included in the 2D video, the character included in the 2D video can made easier to view. In the meantime, when the 3D display device 15 is set in the 2D video display mode, the video reader 134 of the video content playback module 13B may successively output plural 2D video frames, which are included in the 2D video data that is the target of processing, to the image composite module 135 of the display driver program 13C. In this case, the image composite module 135 generates a composite video frame by combining the first image (desktop image), which has been generated by the 2D video generator 133, and the 2D video frame. This composite video frame is displayed on the LCD 15A.

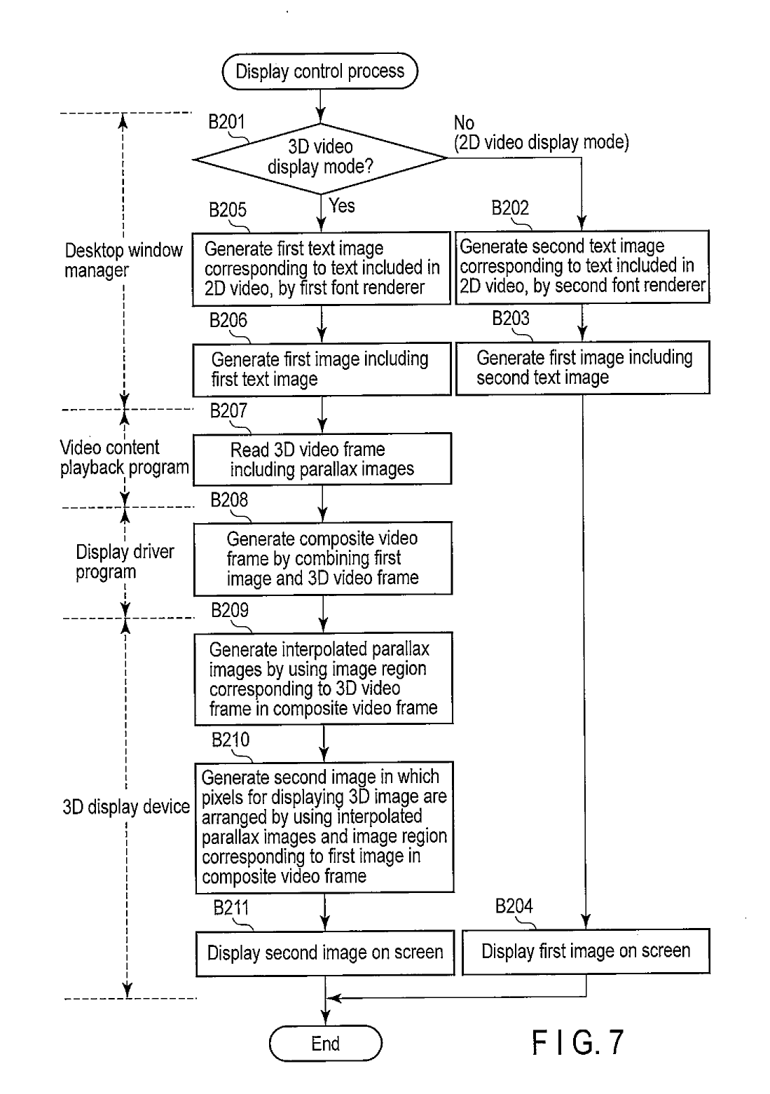

A flowchart of FIG. 7 illustrates another example of the procedure of the display control process which is executed by the computer 1. In the description below, like the case of FIG. 6, it is assumed that 2D video, such as a desktop screen, is displayed on the screen when the 3D display device 15 is set in the 2D video display mode, and 2D video, such as a desktop screen, and 3D video, which is played back by the video content playback program 13B, are displayed on the screen when the 3D display device 15 is set in the 3D video display mode.

To begin with, the display mode determination module 131 of the desktop window manager 130 determines whether the display mode of the 3D display device 15 is the 3D video display mode or not (block B201).

If the display mode of the 3D display device 15 is the 2D video display mode (NO in block B201), the font renderer 132 generates, by the second font renderer provided in the font renderer 132, an image of text (character) (second text image), which is included in 2D video that is to be displayed on the screen (block B202). The text is a character which is used in, e.g. a window, an icon, a taskbar, a toolbar, a dialog, or a pop-up, which is displayed on the screen. In addition, the second font renderer subjects the second text image to an antialiasing process. The 2D image generator 133 generates a first image including the second text image, which has been subjected to the antialiasing process (block B203). For example, the 2D image generator 133 generates a first image by superimposing a second text image corresponding to text on an associated image corresponding to a window, an icon, a button, a taskbar, a toolbar, a dialog, or a pop-up, which is displayed on the screen. Then, the LCD 15A displays the generated first image on the screen (block B204).

On the other hand, if the display mode of the 3D display device 15 is the 3D video display mode (YES in block B201), the font renderer 132 generates, by the first font renderer provided in the font renderer 132, an image of text (character) (first text image), which is included in 2D video that is to be displayed on the screen (block B205). As described above, the text includes a character which is used in, e.g. a window, an icon, a taskbar, a toolbar, a dialog, or a pop-up, which is displayed on the screen. The first font renderer generates the first text image which has not been subjected to the antialiasing process. The 2D image generator 133 generates a first image including the first text image which has not been subjected to the antialiasing process (block B206). Specifically, if the display mode of the 3D display device 15 is the 3D video display mode, the 2D image generator 133 generates a first image including the first text image in which the first font with a thick line width is used. The 2D image generator 133 outputs the generated first image to the image composite module 135 of the display driver program 13C.

Subsequently, the video reader 134 of the video content playback program 13B successively reads a plurality of 3D video frames included in 3D video data that is the target of processing (block B207). The 3D video frame includes a plurality of parallax images corresponding to a plurality of view points (e.g. left-eye video and right-eye video corresponding to two view points) for displaying 3D video. The video reader 134 outputs the read 3D video frame to the image composite module 135.

The image composite module 135 combines the first image, which has been output by the 2D image generator 133, and the 3D video frame which has been output by the video reader 134 (block B208). The image composite module 135 generates a combined video frame (composite video frame), for example, by superimposing the 3D video frame at a predetermined position on the first image (i.e. at a position corresponding to the 3D video display area 52).

Next, the image interpolation module 151 of the 3D display device 151 generates interpolated parallax images by using the image corresponding to the 3D video frame in the composite video frame (block B209). Specifically, the image interpolation module 151 detects, for example, a left-eye image and a right-eye image, which have a first resolution, from the image corresponding to the 3D video frame. The image interpolation module 151 interpolates the left-eye image of the first resolution, thereby generating a left-eye image of a second resolution (for displaying 3D video on the 3D display device 15) which is higher than the first resolution. The image interpolation module 151 also interpolates the right-eye image of the first resolution, thereby generating a right-eye image of the second resolution (for displaying 3D video on the 3D display device 15).

Then, the display image generator 152 generates a display image in which pixels are arranged in accordance with the arrangement of pixels (sub-pixels) on the LCD 15A, by using the generated parallax images (e.g. left-eye image and right-eye image of the second resolution), and the image corresponding to the first image in the composite video frame (block B210). Specifically, the display image generator 152 arranges the pixels, which are included in the image corresponding to the first image, in the associated area in the display image. Then, the display image generator 152 arranges the pixels in the generated parallax images (the pixels included in the left-eye image and the pixels included in the right-eye image), with a predetermined pattern (a pattern for 3D video display). Then, the LCD 15A displays the generated display image on the screen (block B211).

By the above-described process, when 2D video is displayed on the 3D display device 15 that is set in the 3D video display mode, since the image corresponding to the character included in the 2D video has not been subjected to the antialiasing process, the character included in the 2D video can made easier to view.

As has been described above, according to the present embodiment, when 2D video is displayed on the screen for displaying 3D video, the visibility of the character included in the 2D video can be improved. When the 3D display device 15 is set in the 3D video display mode, the font renderer 132 generates the first text image which has not been subjected to the antialiasing process, for example, by using the first font data 21A with a thick line width. Then, using the generated first text image, the 2D image generator 133 generates the first image such as a desktop screen. By displaying this first image on the 3D display device 15 that is set in the 3D video display mode, the character in the first image can be made easier to view.

All the procedures of the display control process of the embodiment may be executed by software. Thus, the same advantageous effects as with the embodiment can easily be obtained simply by installing a program, which executes the procedures of the display control process, into an ordinary computer through a computer-readable storage medium which stores the program, and executing this program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a text image generator configured to generate a first text image when a display is set in a three-dimensional video display mode and a second text image when the display device is set in a two-dimensional video display mode, wherein the first text image is different from a second text image;
a first image generator configured to generate a first image for displaying two-dimensional video, wherein the first image comprises the first text image;
a video composite module configured to generate a composite video frame by combining the first image and a video frame comprising a plurality of images for displaying three-dimensional video; and
a display image generator configured to generate, by using the composite video frame, an image for display on a screen of the display.

2. The electronic apparatus of claim 1, wherein the second text image comprises an image of a character having a second font, and
wherein the first text image comprises an image of a character having a first font, wherein the first font has a greater line width than the second font.

3. The electronic apparatus of claim 1, wherein the second text image comprises an image of a character subjected to an antialiasing process, and
wherein the first text image comprises an image of a character not subjected to the antialiasing process.

4. The electronic apparatus of claim 1, further comprising a parallax image generator configured to generate a plurality of parallax images by using the plurality of images for displaying the three-dimensional video in the composite video frame,
wherein the display image generator is configured to generate the display image comprising the first image in the composite video frame and the plurality of generated parallax images.

5. The electronic apparatus of claim 4, wherein the display image generator is configured to arrange pixels in the plurality of parallax images in the display image in a pattern for displaying three-dimensional video.

6. The electronic apparatus of claim 1, further comprising a display controller configured to control displaying the display image on the screen.

7. The electronic apparatus of claim 1, wherein the display comprises a lens unit comprising a plurality of lenses for emitting a plurality of light rays in directions, the plurality of light rays corresponding to a plurality of pixels in the display image displayed on the screen.

8. A display control method comprising:
generating a first text image when a display is set in a three-dimensional video display mode and a second text image when the display is set in a two-dimensional video display mode, wherein the first text image is different than the second text image;
generating a first image for displaying two-dimensional video, the first image comprising the first text image;
generating a composite video frame by combining the first image and a video frame comprising a plurality of images for displaying three-dimensional video; and
generating a display image by using the composite video frame, the display image displayed on a screen of the display.

9. A computer-readable, non-transitory storage medium having stored thereon a program which is executable by a computer, the program controlling the computer to execute functions of:
generating a first text when a display is set in a three-dimensional video display mode and a second text image when the display is set in a two-dimensional video display mode, wherein the first text image is different than the second text image;
generating a first image for displaying two-dimensional video, the first image comprising the first text image;
generating a composite video frame by combining the first image and a video frame comprising a plurality of images for displaying three-dimensional video; and
generating a display image by using the composite video frame, the display image displayed on a screen of the display.
